(19) United States
(12) Patent Application Publication
(10) Pub. No.: US 2005/0228952 A1
(43) Pub. Date: Oct. 13, 2005

(54) Cache coherency mechanism

(76) Inventors: David Mayhew, Northborough, MA (US); Karl Meier, Wellesley, MA (US); Todd Comins, Chelmsford, MA (US)

Correspondence Address: NIELDS & LEMACK, 176 EAST MAIN STREET, SUITE 7, WESTBORO, MA, 01581, US

(21) Appl. No.: 10/823,300

(22) Filed: Apr. 13, 2004

(51) Int. Cl. G06F 12/00

(52) U.S. Cl. 711/133; 711/144; 711/145

(57) ABSTRACT

The present invention minimizes the amount of traffic that traverses the fabric in support of the cache coherency protocol. It also allows rapid transmission of all traffic associated with the cache coherency protocol, so as to minimize latency and maximize performance. A fabric is used to interconnect a number of processing units together. The switches are able to recognize incoming traffic related to the cache coherency protocol and then move these messages to the head of that switch's output queue to insure fast transmission. Also, the traffic related to the cache coherency protocol can interrupt an outgoing message, further reducing latency. The switch incorporates a memory element, dedicated to the cache coherency protocol, which tracks the contents of all of the caches of all of the processors connected to the fabric. In this way, the fabric can selectively transmit traffic only to the processors where it is relevant.

### BACKGROUND OF THE INVENTION

Today's computer systems continue to become increasingly complex. First, there were single central processing units, or CPUs, used to perform a specific function. As the complexity of software increased, new computer systems emerged, such as symmetric multiprocessing, or SMP, systems, which have multiple CPUs operating simultaneously, typically utilizing a common high-speed bus. These CPUs all have access to the same memory and storage elements, with each having the ability to read and write to these elements. More recently, another form of multi-processor system has emerged, known as Non-Uniform Memory Access, or “NUMA”. NUMA refers to a configuration of CPUs, all sharing common memory space and disk storage, but having distinct processor and memory subsystems. Computer systems having processing elements that are not tightly coupled are also known as distributed computing systems. NUMA systems can be configured to have a global shared memory, or alternatively can be configured such that the total amount of memory is distributed among the various processors. In either embodiment, the processors are not as tightly bound together as with SMP over a single high-speed bus. Rather, they have their own high-speed bus to communicate with their local resources, such as cache and local memory. A different communication mechanism is employed when the CPU requires data elements that are not resident in its local subsystem. Because the performance is very different when the processor accesses data that is not local to its subsystem, this configuration results in non-uniform memory access. Information in its local memory will be accessed most quickly, while information in other processor's local memory is accessed more quickly than accesses to disk storage.

In most embodiments, these CPUs possess a dedicated cache memory, which is used to store duplicate versions of data found in the main memory and storage elements, such as disk drives. Typically, these caches contain data that the processor has recently used, or will use shortly. These cache memories can be accessed extremely quickly, at much lower latency than typical main memory, thereby allowing the processor to execute instructions without stalling to wait for data. Data elements are added to the cache in “lines”, which is typically a fixed number of bytes, depending on the architecture of the processor and the system.

Through the use of cache memory, performance of the machine therefore increases, since many software programs execute code that contains “loops” in which a set of instructions is executed and then repeated several times. Most programs typically execute code from sequential locations, allowing caches to predictively obtain data before the CPU needs it—a concept known as prefetching. Caches, which hold recently used data and prefetch data that is likely to be used, allow the processor to operate more efficiently, since the CPU does not need to stop and wait for data to be read from main memory or disk.

With multiple CPUs each having their own cache and the ability to modify data, it is desirous to allow the caches to communicate with each other to minimize the number of main memory and disk accesses. In addition, in systems that allow a cache to modify its contents without writing it back to main memory, it is essential that the caches communicate to insure that the most recent version of the data is used. Therefore, the caches monitor, or “snoop”, each other's activities, and can intercept memory read requests when they have a local cached copy of the requested data.

In systems with multiple processors and caches, it is imperative that the caches all contain consistent data; that is, if one processor modifies a particular data element, that change must be communicated and reflected in any other caches containing that same data element. This feature is known as “cache coherence”.

Thus, a mechanism is needed to insure that all of the CPUs are using the most recently updated data. For example, suppose one CPU reads a memory location and copies it into its cache and later it modifies that data element in its cache. If a second CPU reads that element from memory, it will contain the old, or “stale” version of the data, since the most up-to-date, modified version of that data element only resides in the cache of the first CPU.

The easiest mechanism to insure that all caches have consistent data is to force the cache to write any modification back to main memory immediately. In this way, CPUs can continuously read items in their cache, but once they modify a data element, it must be written to main memory. This trivial approach to maintaining consistent caches, or cache coherency, is known as write through caching. While it insures cache coherency, it affects performance by forcing the system to wait whenever data needs to be written to main memory, a process which is much slower than accessing the cache.

There are several more sophisticated cache coherency protocols that are widely used. The first is referred to as “MESI”, which is an acronym for Modified, Exclusive, Shared, and Invalid. These four words describe the potential state of each cache line.

To illustrate the use of the MESI protocol, assume that CPU 1 needs a particular data element, which is not contained in its cache. It issues a request for the particular cache line. If none of the other caches has the data, it is retrieved from main memory or disk and loaded into the cache of CPU 1, and is marked “E” for exclusive, indicating that it is the only cache that has this data element. If CPU 2 later needs the same data element, it issues the same request that CPU 1 had issued earlier. However, in this case, the cache for CPU 1 responds with the requested data. Recognizing that the data came from another cache, the line is saved in the cache of CPU 2, with a marking of “S”, or shared. The cache line of CPU 1 is now modified to “S”, since it shared the data with the cache of CPU 2, and therefore no longer has exclusive access to it. Continuing on, if CPU 2 (or CPU 1) needs to modify the data, it checks the cache line marker and since it is shared, issues an invalidate message to the other caches, signaling that their copy of the cache line is no longer valid since it has been modified by CPU 2. CPU 2 also changes the marker for this cache line to “M”, to signify that the line has been modified and that main memory does not have the correct data. Thus, CPU 2 must write this cache line back to main memory before other caches can use it, to restore the integrity of main memory. Therefore, if CPU 1 needs this data element, CPU 2 will detect the request, it will then write the modified cache line back to main memory and change the cache line marker to “S”. Table 1 briefly describes the four states used in this cache coherency protocol.

TABLE 1

| State | Description |
|---|---|
| Modified | The cache line is valid in this cache and |
| | no other cache. A transition to this state |
| | requires an invalidate message to be |
| | broadcast to the other caches. |
| | Main memory is not up to date |
| Exclusive | The cache line is in this cache and no |
| | other cache. |
| | Main memory is up to date |
| Shared | The cache line is valid in this cache and |
| | at least one other cache. |
| | Main memory is up to date |
| Invalid | The cache line does not reside in the |
| | cache or does not contain valid data |

This scheme reduces the number of accesses to main memory by having the various caches snoop each other's requests before allowing them to access main memory or disk. However, this scheme does not significantly reduce the number of write accesses to main memory, since once a cache line achieves a status of “M”, it must be written back to main memory before another cache can access it to insure main memory integrity. A second cache coherency protocol, referred to as “MOESI”, addresses this issue. “MOESI” represents the acronym for Modified, Owner, Exclusive, Shared and Invalid. In most scenarios, it operates like the MESI protocol described above. However, the added state of Owner allows a reduction in the number of write accesses to main memory.

To illustrate the use of the MOESI protocol, the previous example will be repeated. Assume that CPU 1 needs a particular data element, which is not contained in its cache. It issues a request for the particular cache line. If none of the other caches h the data, it is retrieved from main memory or disk and loading into the cache of CPU 1, and is marked “E” for exclusive, indicating that it is the only cache that has this data element. If CPU 2 later needs the same data element, it issues the same request that CPU 1 had issued earlier. However, in this case, the cache for CPU 1 responds with the requested data. Recognizing that the data came from another cache, the line is entered into the cache of CPU 2, with a marking of “S”, or shared. The cache line of CPU 1 is now modified to “S”, since it shared the data with CPU 2, and therefore no longer has exclusive access to it. Continuing on, if CPU 2 (or CPU 1) needs to modify the data, it checks the cache line marker and since it is shared, issues an invalidate message to the other caches, signaling that their copy of the cache line is no longer valid since it has been modified by CPU 2. CPU 2 also changes the marker for this cache line to “M”, to signify that the line has been modified and that main memory does not have the correct data. If CPU 1 requests the data that has been modified, the cache of CPU 2 supplies it to CPU 1, and changes the marker for this cache line to “O” for owner, signifying that it is responsible for supplying the cache line whenever requested. This state is roughly equivalent to a combined state of Modified and Shared, where the data exists in multiple caches, but is not current in main memory. If CPU 2 again modifies the data while in the “O” state, it changes its marker to “M” and issues an invalidate message to the other caches, since their modified copy is no longer current. Similarly, if CPU 1 modifies the data that it received from CPU 2, it changes the marker for the cache line to “M” and issues an invalidate message to the other caches, including CPU 2, which was the previous owner. In this way, the modified data need not be written back, since the use of the M, S, and O states allow the various caches to determine which has the most recent version.

These schemes are effective at reducing the amount of accesses to main memory and disk. However, each requires a significant amount of communication between the caches of the various CPUs. As the number of CPUs increases, so too does the amount of communication between the various caches. In one embodiment, the caches share a single high-speed bus and all of the messages and requests are transmitted via this bus. While this scheme is effective with small numbers of CPUs, it becomes less practical as the numbers increase. A second embodiment uses a ring structure, where each cache is connected to exactly two other caches, one from which it receives data (upstream) and the other to which it sends data (downstream), via point to point connections. Messages and requests from one cache are passed typically in one direction to the downstream cache, which either replies or forwards the original message to its downstream cache. This process continues until the communication arrives back at the original sender's cache. While electrical characteristics are more trivial than on a shared bus, the latency associated with traversing a large ring can become unacceptable.

A third embodiment incorporates a network fabric, incorporating one or more switches to interconnect the various CPUs together. Fabrics overcome the electrical issues associated with shared busses since all connections are point-to-point. In addition, they typically have lower latency than ring configurations, especially in configurations with many CPUs. However, large multiprocessor systems will create significant amounts of traffic related to cache snooping. This traffic has the effect of slowing down the entire system, as these messages can cause congestion in the switch.

Therefore, it is an object of the present invention to provide a system and method for operating a cache coherent NUMA system with a network fabric, while minimizing the amount of traffic in the fabric. In addition, it is a further object of the present invention to provide a system and method to allow rapid transmission and reduced latency of the cache snoop cycles and requests through the switch.

### SUMMARY OF THE INVENTION

The problems of the prior art have been overcome by the present invention, which provides a system for minimizing the amount of traffic that traverses the fabric in support of the cache coherency protocol. The system of the present invention also allows rapid transmission of all traffic associated with the cache coherency protocol, so as to minimize latency and maximize performance. Briefly, a fabric is used to interconnect a number of processing units together. The switches that comprise the fabric are able to recognize incoming traffic related to the cache coherency protocol. These messages are then moved to the head of the switch's output queue to insure fast transmission throughout the fabric. In another embodiment, the traffic related to the cache coherency protocol can interrupt an outgoing message, further reducing latency through the switch, since the traffic does not need to wait for the current packet to be transmitted.

The switches within the fabric also incorporate at least one memory element, which is dedicated to analyzing and storing transactions related to the cache coherency protocol. This memory element tracks the contents of the caches of all of the processors connected to the switch. In this manner, traffic can be minimized. In a traditional NUMA system, read requests and invalidate messages are communicated with every other processor in the system. By tracking the contents of each processor's cache, the fabric can selectively transmit this traffic only to the processors where the data is resident in its cache.

### BRIEF DESCRIPTION OF THE DRAWINGS

FIG. 1 is a schematic diagram illustrating a first embodiment of the present invention;

FIG. 2 is a schematic diagram illustrating a second embodiment of the present invention;

FIG. 3a is a schematic diagram illustrating delivery of packets as performed in the prior art;

FIG. 3b is a schematic diagram illustrating a mechanism for reducing the latency of message transmission in accordance with one embodiment of the present invention;

FIG. 3c is a schematic diagram illustrating a mechanism for reducing the latency of message transmission in accordance with a second embodiment of the present invention;

FIG. 4 is a chart illustrating a representative format for a directory in accordance with an embodiment of the present invention;

FIG. 5 is a chart illustrating the states of a directory during a sequence of operations in a single switch fabric in accordance with an embodiment of the present invention; and

FIG. 6 is a chart illustrating the states of directories during a sequence of operations in a multi-switch fabric in accordance with an embodiment of the present invention.

### DETAILED DESCRIPTION OF THE INVENTION

Cache coherency in a NUMA system requires communication to occur among all of the various caches. While this presents a manageable problem with small numbers of processors and caches, the complexity of the problem increases as the number of processors increased. Not only are there more caches to track, but also there is a significant increase in the number of communications between these caches necessary to insure coherency. The present invention reduces that number of communications by tracking the contents of each cache and sending communications only to those caches that have the data resident in them. Thus, the amount of traffic created is minimized.

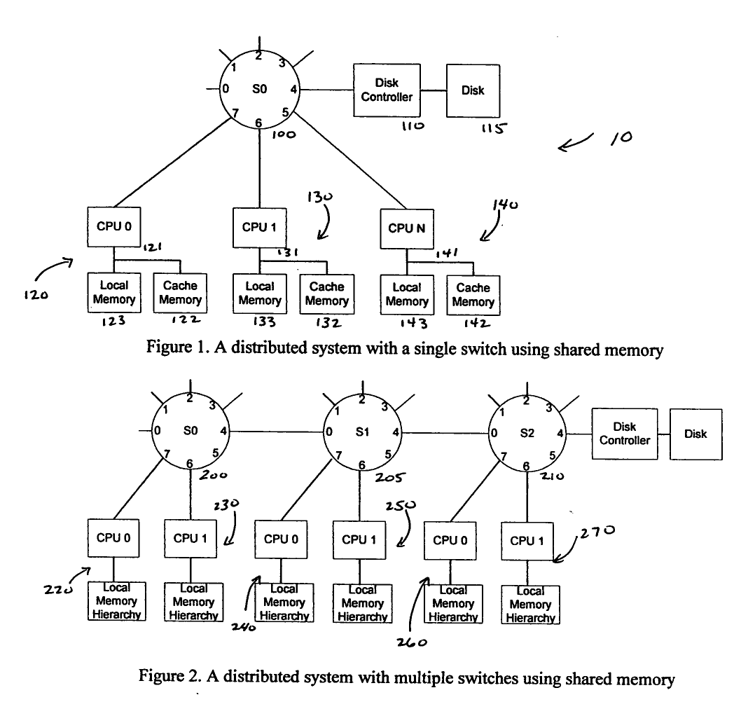

FIG. 1 illustrates a distributed processing system, or specifically, a shared memory NUMA system 10 where the various CPUs are all in communication with a single switch. This switch is responsible for routing traffic between the processors, as well as to and from the disk storage 115. In this embodiment, CPU subsystem 120, CPU subsystem 130 and CPU subsystem 140 are each in communication with switch 100 via an interconnection, such as a cable, back plane or a interconnect on a printed circuit board. CPU subsystem 120 comprises a central processing unit 121, which may include one or more processor elements, a cache memory 122, and a local memory 123. Likewise, CPU subsystems 130 and 140 comprise the same elements. In communication with switch 100 is disk controller 110, which comprises the control logic for the disk storage 115, which may comprise one or more disk drives. The total amount of memory in distributed system 10 is contained and partitioned between the various CPU subsystems. The specific configuration of the memory can vary and is not limited by the present invention. For illustrative purposes, it will be assumed that the total system memory is equally divided between the processor subsystems.

Since the total system memory is divided among the processor subsystems, each processor must access memory that is local to other processor subsystems. These accesses are much slower than accesses by the processor to its own local memory, and therefore impact performance. To minimize the performance impact of these accesses, each CPU subsystem is equipped with a cache memory. The cache is used to store frequently used, or soon to be used, data. The data stored in the cache might be associated with any of the main memory elements in the system.

As described above, it is essential to maintain cache coherency between the various cache elements in the system. Referring again to FIG. 1, the traditional exchange of information between the various caches using MOESI will be described, as is currently performed in the prior art. Suppose CPU 121 requires a data element that is not in its cache. It issues a read request to switch 100. Switch 100 broadcasts this read request to all other CPU subsystems. Since none of the other caches contains the data, the requested data must be retrieved from main memory, such as local memory 143. This data element is sent to switch 100, which forwards it back to CPU subsystem 120, where it is stored in cache 122. The cache line associated with this data element is marked “E”, since this is the only cache that has the data.

At a later time, assume that CPU 131 requires the same data element. In a similar fashion, it issues a read request to switch 100, which sends a multicast message to the other CPU subsystems. In this case, cache 122 has the requested data and transmits it back to CPU 131, via switch 100. At this point, both cache 122 and 132 have a copy of the data element, which is stored in main memory 143. Both of these caches mark the cache line “S” to indicate shared access.

Later, assume that CPU 141 requires the same data element. It issues a read request to switch 100, which sends a multicast message to the other CPU subsystems. In this case, both cache 122 and cache 132 have the requested data and transmit it back to CPU 141, via switch 100. At this point, caches 122, 132 and 142 all have a copy of the data element, which is stored in main memory 143. All of these caches mark the cache line “S” to indicate shared access.

At a later point in time, assume that CPU 131 modifies the data element. It then also issues an invalidate message informing the other caches that their copy of that cache line is now stale and must be discarded. It also modifies the marker associated with this line to “M”, signifying that it has modified the cache line. The switch 100 receives the invalidate message and broadcasts it to all of the other caches in the system, even though only caches 122 and 142 have that data element.

At a later point, assume that CPU 141 requests the data element and sends a read request to switch 100. Switch 100 sends a multicast message to all of the other systems requesting the data element. Since the modified data exists only in cache 132, it returns the data element to CPU 141, via switch 100. It is then stored in cache 142 and is marked “S”, since the item is now shared. Cache 132 marks the cache line “O”, since it is the owner and has shared a modified copy of the cache line with another system.

At a subsequent time, assume that CPU 141 modifies the data element. An invalidate message is sent to switch 100, which is then broadcast to all of the other CPU subsystems, even though only CPU subsystem 130 has the data element in its cache. The cache line in 142 is now marked “M”, since it has modified the element, and the line is now invalidated in cache 132.

The mechanism described above continues accordingly, depending on the type of data access and the CPU requesting the data. While cache coherency is maintained throughout this process, there are distinct disadvantages to the mechanism described.

First, the cache protocol creates excessive of traffic throughout the network. Each read request and invalidate message is sent to every CPU, even to those that are not involved in the transaction. For example, in the previous scenario, an invalidate message is sent to CPU subsystem 120 after the data element was modified by CPU 141. However, at that point in time, cache 122 does not have the data element in its cache and therefore does not need to invalidate the cache line. Similarly, read requests are transmitted to CPU subsystems that neither have the data in their main memory, nor in their caches. These requests unnecessarily use network bandwidth.

In the scenario described above, each read request from a CPU will generate a read request to every other CPU in the system, and a corresponding response from every other CPU. These responses are then all forwarded back to the requesting CPU. To illustrate this, assume that there are eight CPUs in the system. A read request is send from one of these CPUs to the switch. Then seven read requests are forwarded to the other CPUs, which each generate a response to the request. These seven responses are then forward back to the requesting CPU. Thus, a single read request generates 22 messages within the system. This number grows with additional CPUs. In the general case, the number of messages generated by a single read request is 3*(# of CPUs−1)+1. In a system with 16 CPUs, a total of 46 messages would be generated.

The second disadvantage of the current mechanism is that latency through the switch cannot be determined. For example, when the read request arrives at switch 100 and is ready to be broadcast to all other CPU subsystems, the switch queues the message at each output queue. If the queue is empty, the read request will be sent immediately. If, however, the queue contains other packets, the message is not sent until it reaches the head of the queue. In fact, even if the queue is empty, the read request must still wait until any currently outgoing message has been transmitted. Similarly, when a cache delivers the requested data back to the switch, latency is incurred in delivering that data to the requesting CPU.

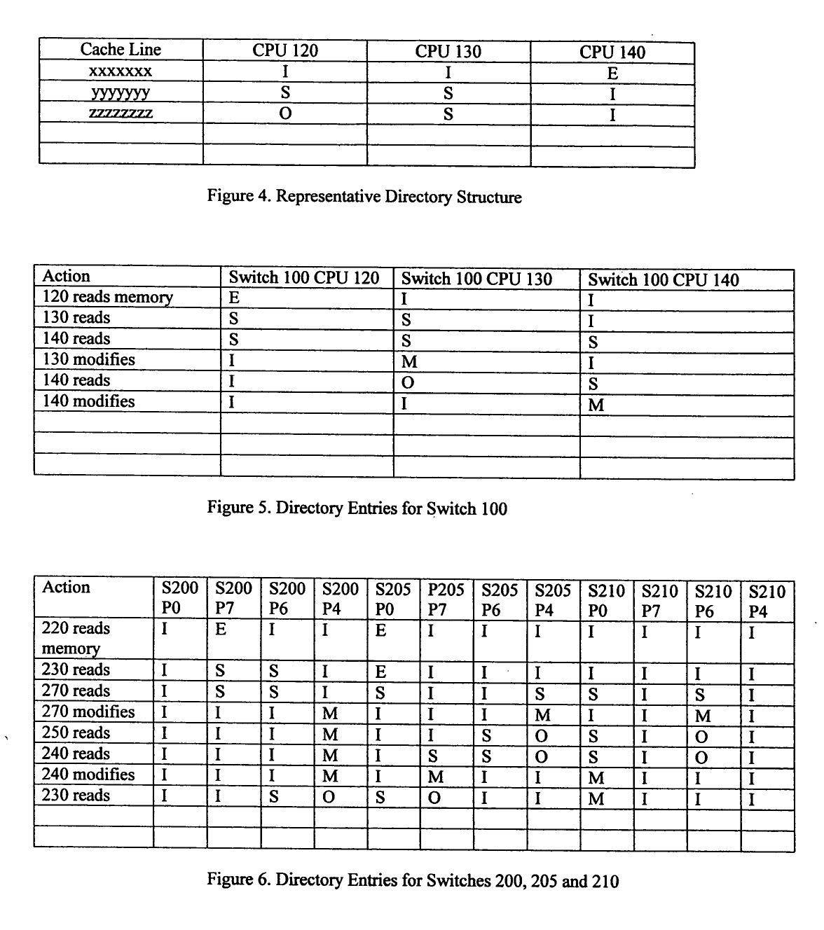

The present invention reduces the amount of traffic in the network, thus reducing congestion and latency. By tracking the actions of the CPU subsystems, it is possible for switch 100 to determine where the requested data resides and limit network traffic only to those subsystems. The present invention will be described in relation to the scenario given above. Switch 100 contains internal memory, a portion of which is used to create a directory of cache lines. The specific format and configuration of the directory can be implemented in various ways, and this disclosure is not limited to any particular directory format. FIG. 4 shows one possible format, which will be used to describe the invention. The table of FIG. 4 contains multiple entries. There is an entry for each cache line, and this is accompanied by the status of that cache line in each CPU subsystem. These entries may be static, where the memory is large enough to support every cache line. Alternatively, entries could be added as cache lines become populated and deleted as lines become invalidated, which may result in a small directory structure. At initialization, the table is configured to accommodate all of the CPU subsystems in the NUMA system. Each entry is marked as “I” for invalid, since there is no valid cache data yet. The state of the directory in switch 100 during the following sequence of operations can be seen in FIG. 5.

Returning to the previous scenario, suppose CPU 121 requires a data element that is not in its cache. It issues a read request to switch 100. Switch 100 checks the directory and finds that there is no entry for the requested data. It then broadcasts this read request to all other CPU subsystems. Since none of the other caches contain the data, the requested data must be retrieved from main memory, such as local memory 143. This data element is sent to switch 100, which forwards it back to CPU subsystem 120, where it is stored in cache 122. Within CPU subsystem 120, the cache line associated with this data element is marked “E”, since this is the only cache that has the data. The switch also updates its directory, by adding an entry for this cache line. It then denotes that CPU 120 has exclusive access “E”, while all other CPUs remain invalid “I”. This is shown in row 1 of FIG. 5.

At a later time, CPU 131 requires the same data element. In a similar fashion, it issues a read request to switch 100. Switch 100 checks the directory and in this case discovers that the requested data element exists in CPU subsystem 120. Rather than sending a multicast message to all of the other CPU subsystems, switch 100 sends a request only to CPU subsystem 120. Cache 122 has the requested data and transmits it back to CPU subsystem 130, via switch 100. At this point, both cache 122 and 132 have a copy of the data element, which is stored in main memory 143. Both of these caches mark the cache line “S” for shared. Switch 100 then updates its directory to reflect that CPU 120 and CPU 130 both have shared access, “S”, to this cache line. This is illustrated in row 2 of FIG. 5.

Later, CPU subsystem 140 requires the same data element. It issues a read request to switch 100, which indexes into the directory and finds that both CPU subsystem 120 and CPU subsystem 130 have the requested data in their caches. Based on a pre-determined algorithm, the switch sends a message to one of these CPU subsystems, preferably the least busy of the two. The algorithm used in not limited by this invention and may be based on various network parameters, such as queue length or average response time. The requested data is then transmitted back to CPU subsystem 140, via switch 100. At this point, caches 122, 132 and 142 all have a copy of the data element, which is stored in main memory 143. All of these caches mark the cache line “S” for shared. The switch then updates the directory to indicate that CPU 120, 130 and 140 all have shared access “S” to this data as illustrated in row 3 of FIG. 5.

At a later point in time, CPU subsystem 130 modifies the data element. It also issues an invalidate message informing the other caches that their copy of that cache line is now stale and must be discarded. It also modifies the marker associated with this line to “M”, signifying that it has modified the cache line. The switch 100 receives the invalidate message and compares the cache line being invalidated to the directory. Based on this comparison, it sends the invalidate message only to CPU subsystems 120 and 140, which are the only other subsystems that had the cache line. As shown in row 4 of FIG. 5, the switch then updates the directory to mark CPU subsystem 120 and CPU subsystem 140 as invalid “I” and CPU subsystem 130 as modified “M”.

At a later point, CPU subsystem 140 requests the data element and sends a read request to switch 100. Switch 100 indexes into the directory and finds that CPU 130 has a modified copy of this cache line. It then sends a message to that subsystem requesting the data. Subsystem 130 returns the data element to CPU subsystem 140, via switch 100. It is then stored in cache 142 and is marked “S”, since the item is shared. Cache 132 marks the cache line “O”, since it is the owner and has shared a modified copy of the cache line with another system. The switch now updates the directory to note that CPU 130 is the owner “O” and CPU 140 has shared access “S”, as shown in row 5 of FIG. 5.

At a subsequent time, CPU subsystem 140 modifies the data element. An invalidate message is sent to switch 100, which then indexes into the directory. It sends the invalidate message to CPU 130. The cache line in 142 is now marked “M”, since it has modified the element, and the line is now invalidated in cache 132. Similarly, the switch updates the directory by marking the CPU 140 as modified “M” and CPU 130 as invalid “I”. This is shown in row 6 of FIG. 5.

This invention significantly reduces network traffic because the switch is aware of the status of all subsystems and is able to restrict traffic to only those that are relevant to the current transaction. The previous example demonstrated that 22 messages were generated in response to a single read request. In accordance with the present invention, that number is reduced significantly. Assume again that there are eight CPUs in the system, with one issuing a read request. That request is analyzed by the switch, which passes it to only one CPU having the requested data. That CPU returns the data to the switch, which forwards it back to the requesting CPU. This is a total of four messages for the same read request that required 22 messages in the prior art. Additionally, the number of messages generated is no longer a function of the number of CPUs; it remains 4 regardless of the number of processing units in the system.

Although the present invention has been described in relation to the MOESI cache coherency protocol, it is equally applicable using the MESI protocol as well.

While the previous description comprised only a single switch to which all of the CPU subsystems were connected, the invention is not limited to this configuration. Any number of switches can be used, depending on the number of CPU subsystems involved and the maximum allowable latency. FIG. 2 shows a distributed network having a plurality of switching devices, each connected to a number of CPU subsystems. CPU subsystems 220 and 230, comprising the same elements of a processing unit, cache and local memory as those described above, are in communication with switch 200, via ports 7 and 6, respectively. Similarly, CPU subsystems 240 and 250 are in communication with switch 205 via ports 7 and 6 respectively and CPU subsystems 260 and 270 are in communication with switch 210 via ports 7 and 6 respectively. Port 4 of switch 200 is also in communication with port 0 of switch 205, and port 4 of switch 205 is in communication with port 0 of switch 210.

Each of the three switches contains a directory as described in FIG. 4. However, since all of the CPUS are not visible from any single switch, each may possess an incomplete version of the actual directory. In one embodiment, the directory is made up of cache line entries, and cache status entries associated with each port. The contents of the respective directories after each of the following operations are shown in FIG. 6.

Suppose CPU subsystem 220 requests data that exists in the main memory of CPU subsystem 250. The request is transmitted to switch 200, which detects that it has no cache line entries for this data. It then sends a request to all of nits ports, including CPU subsystem 230 and switch 205. Switch 205 repeats this process, sending requests to CPU subsystem 240, CPU subsystem 250 and switch 210. Lastly, switch 210 sends the request to CPU subsystems 260 and 270. CPU subsystem 250 responds with the requested data, which was located in its local memory. This data is sent to switch 200, which requested the data. Switch 200 then transmits the data to the requesting CPU 220. At this point, the directory for switch 200 indicates that port 7 has exclusive “E” access of this cache line. Similarly, the directory in switch 205 is updated to indicate that port 0 has exclusive access “E” of this cache line. Since the transaction did not pass through switch 210, its directory remains invalid. These states are illustrated in row 1 of FIG. 6.

Later, CPU subsystem 230 requests the same data element. Switch 200 indexes into its directory and sends the request to CPU subsystem 220 via port 7. The data is returned to CPU subsystem 230 via switch 200. The switch updates its directory to indicate that ports 7 and 6 have shared access “S” to the cache line. Switch 205 and 210 never see this transaction and therefore their directories are unchanged, as illustrated in row 2 of FIG. 6.

At a later time, CPU subsystem 270 requests the same data line. Switch 210 has no entries corresponding to this cache line, so its send the request to all of its ports. Switch 205 receives the read request and indexes into its directory and finds that port 0 has exclusive access to the cache line. Switch 205 then forwards the read request to port 0. Switch 200 receives the request and determines that both port 7 and 6 have the requested data. It then uses an algorithm to select the preferred port and sends the request to the selected port. As before, the algorithm attempts to identify the port which will return the data first, based on number of hops, average queue length, and other network parameters. When the switch receives the requested data, it forwards it via port 4 to switch 205, which then forwards it to switch 210. Switch 210 forwards it to requesting CPU subsystem 270. Switch 200 updates its directory to indicate that ports 7, 6 and 4 have shared access. Switch 205 updates its directory to indicate that ports 0 and 4 have shared access. Switch 210 updates its directory to indicate that port 0 and port 6 have shared access. This status update is shown in row 3 of FIG. 6.

Later, CPU subsystem 270 modifies the cache line. It sends an invalidate message to switch 210. Switch 210 indexes into its directory and determines that port 0 has shared access and sends an invalidate message to this port. Switch 205 receives the invalidate message and determines that ports 0 and 4 have shared access and therefore forwards the invalidate message to port 0. Switch 200 receives the invalidate message, and forwards it to ports 7 and 6, based on its directory entry. Switch 200 invalidates the entry for that cache line in its directory for ports 7 and 6, and updates port 4 to “M”. Switch 205 invalidates the entry for port 0 and updates its port 4 to “M”. Switch 210 updates its directory to indicate that port 0 is invalid and that port 6 has modified “M” the cache line. The updated directory entries are illustrated in row 4 of FIG. 6.

Later, CPU subsystem 250 requests the same data element. Switch 205 indexes into its directory and determines that the entry has been modified by port 4. It then sends the request via port 4. Switch 210 receives the request and determines that the valid data exists in CPU subsystem 270, so the request is transmitted via port 6. The data is returned via port 0 to switch 205, which then delivers it to CPU subsystem 250 via port 6. Switch 205 updates its directory to indicate that port 6 now has shared “S” access and port 4 has owner “O” status. Switch 210 updates its directory to indicate that port 0 has shared access and port 6 has owner status. Switch 200 is unaware of this transaction and therefore its directory is unchanged. The updated directory entries are shown in row 5 of FIG. 6.

Later, CPU subsystem 240 requests the same data element. Switch 205 determines that port 6 has shared access and port 4 has owner status. Based on its internal algorithm, it then forwards the read request to the appropriate port. Assuming that the algorithm determines that port 6 has the least latency, the directory in switch 205 is then modified to include shared access for port 7, leaving the directories in the other switches unchanged, as shown in row 6 of FIG. 6.

When, at a later time, CPU subsystem 240 modifies the data element, it sends an invalidate message to switch 205. Switch 205 then sends that message to ports 6 and 4, based on its directory. It also updates the directory to indicate that port 4 has modified access and all other ports are invalid. Switch 210 gets the invalidate message and delivers it to port 6, where CPU subsystem 270 resides. It then updates its directory to indicate that port 0 has modified access and all other ports are invalid. The directory in switch 200 is unaltered, as illustrated in row 7 of FIG. 6.

Later, CPU subsystem 230 reads the data element. Switch 200 determines from its directory that port 4 has modified the cache line and forwards the request to switch 205. Similarly, switch 205 determines from its directory that port 7 has valid data and forwards the request to CPU subsystem 240. The data is then delivered back to switch 200. Switch 205 then updates its directory to indicate that port 0 has shared access and port 7 has owner status. Switch 200 updates its directory to indicate that port 6 has shared access and port 4 has owner access, as shown in row 8 of FIG. 6.

While this example employed the MOESI protocol, the invention is equally applicable with the MESI protocol as well.

Similarly, although this example assumes that the total memory space is divided among the various processor subsystems, the invention is not so limited. A memory element, containing part or all of the system memory, can exist as a network device. This memory element is in communication with the switch. In this embodiment, the switch sends the read requests to the memory element in the event that none of the cache memories contains that required data element. All write operations would also be directed to this memory element.

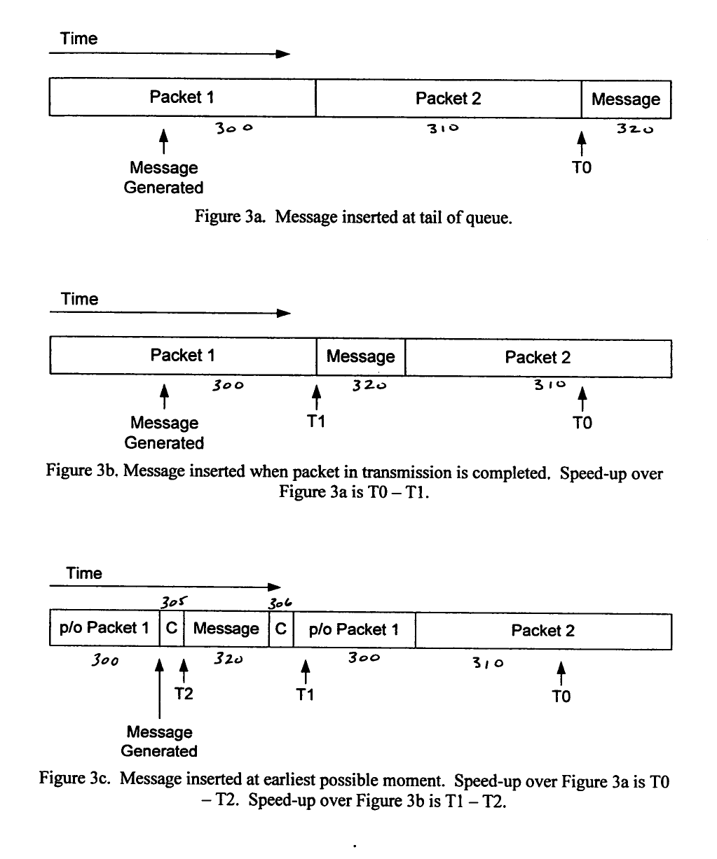

The present invention also reduces the latency associated with queuing in the switches. Latency is reduced via two techniques, which can be used independently or in combination. FIG. 3a illustrates the issue of transmission latency. In this figure, a cache coherency related communication 320, such as a read request, invalidate message or cache data, is scheduled to be transmitted after packet 300 and packet 310. Thus, latency is introduced and the entire system is slowed. Using the first technique, the switch recognizes that the message is associated with the cache coherency protocol (either a read request, an invalidate message or returned cache data). Upon detection, the switch attempts to reduce the latency by moving message 320 ahead of other messages destined for transmission. This is achieved by inserting message 320 at the head of the queue, thereby bypassing all other packets that are waiting to be sent. Alternatively, a separate “high priority” queue can be utilized, whereby the switch's scheduling mechanism prioritizes packets in that queue ahead of the normal output queue. The resulting timeline is shown in FIG. 3b. In this figure, packet 300 is already in the process of being transmitted and is allowed to complete. However, message 320 can be placed ahead of packet 310 in the queue, or placed in a separate “high priority” queue, allowing it to be transmitted after packet 300. This results in a significant reduction in latency, however the cache coherency protocol message may still incur latency if packet 300 is a large packet requiring considerable transmission time.

FIG. 3c illustrates a second mechanism to reduce latency for cache coherency protocol communications. Using this technique, the switch recognizes that the communication is related to cache coherency and moves it to the head of the queue, or places it in a “high priority” queue. If a message is already being transmitted, that transmission is interrupted, so that the message can be sent. In FIG. 3c, packet 300 is in the process of being transmitted. At some point during that transmission, message 320 is received by switch 100. The switch prepares to send message 320, such as by placing it in a “high priority” queue. The scheduling mechanism detects that a packet has been placed on the high priority queue. It then interrupts packet 300, sends a special delimiter 305, which is recognized as being distinct from the data in packet 300. This delimiter signifies to the receiving device that packet 300 is being interrupted and a message is being inserted into the middle of packet 300. Following the delimiter 305, message 320 is transmitted, followed by a second delimiter 306, which can be the same or different from the first. This second delimiter signifies to the receiving device that transmission of message 320 is complete and that transmission of packet 300 is being resumed. The rest of packet 300 is then transmitted as usual.

At the receiving device, the special delimiter 305 is detected and the device then stores the message in a separate location until it reaches the second delimiter. Message 320 can then be processed. The device then continues receiving packet 300, and subsequently receives packet 310.

By interrupting the transmission of packets already in progress, the latency for all cache coherency related communications is nearly eliminated. By implementing these mechanisms, the total latency is based upon the processing time of the device and actual transmission time, with almost no deviations due to network traffic. This allows a network fabric, which is also transmitting other types of information, to be used for this time critical application as well.

1. A computing system comprising a plurality of computing subsystems, each subsystem comprising a processing unit for executing instructions and a local cache memory element for storing a local copy of one or more data elements for high-speed access by said processing unit; and a network switching element comprising a plurality of ports and a storage element, each of said plurality of subsystems being in communication with a different port of said network switching element, said switching element being adapted to monitor transactions transmitted via said ports and generated by said plurality of subsystems, interpret said transactions to determine the status of each of said cache memory elements, and store said status information in said storage element, and route future transactions to a subset of said subsystems based on said stored status information.

2. The system of claim 1, wherein said status information comprises the states of invalid, modified, shared and exclusive for each cache line in each of said local cache memory elements.

3. The system of claim 2, wherein said status information further comprises the state of owner.

4. The system of claim 1, further comprising a shared memory accessible to each of said plurality of subsystems in communication with said switching element.

5. The system of claim 1, wherein said transactions comprise memory read, memory write and cache invalidate operations.

6. The system of claim 1, wherein said subset of subsystems comprises subsystems in which the cache memory contains the data element described in said future transaction.

7. A method of reducing traffic between a plurality of processor subsystems in a distributed processing system through a network switching element, where each of said plurality comprises at least one processing unit and a cache memory element, said method comprising the steps of:
monitoring all transactions transmitted by said plurality of subsystems to said switching element;
interpreting said transactions to deduce the status of said cache memory element in each of said plurality of subsystems;
storing said status information associated with each of said cache memory elements in said network switching element; and
routing future transactions to a subset of said plurality of subsystems-based on said status information.

8. A method of reducing the latency of time critical transmissions through a network switching device, where said latency is defined as the time between receipt of said time critical transmission via a first port and the resending of said time critical transmission via a second port, comprising the steps of:
receiving a first transmission via said first port;
identifying said first transmission as a time critical transmission;
sending said first transmission via said second port if said second port is idle;
if said second port is not idle, interrupting a second transmission currently in progress via said second port, transmitting a first delimiter to notify recipient of said second transmission that said second transmission is being interrupted,
transmitting said first transmission via said second port,
transmitting a second delimiter to notify recipient of said first and second transmissions that said first transmission has been sent and said second transmission is being resumed, and
transmitting the remainder of said second transmission.
